(19) United States
(12) Patent Application Publication
(10) Pub. No.: US 2017/0345165 A1
(43) Pub. Date: Nov. 30, 2017

(54) Correcting Short Term Three-Dimensional Tracking Results

(71) Applicant: Intel Corporation, Santa Clara, CA (US)

(72) Inventors: David Stanhill, Hoshaya (IL); Ziv Aviv, Bat Hefer (IL)

(21) Appl. No.: 15/166,595

(22) Filed: May 27, 2016

(51) Int. Cl. G06T 7/269; G06T 7/50; G06T 7/55

(52) U.S. Cl. CPC G06T 7/269; G06T 7/55; G06T 7/50; G06T 2207/10012; G06T 2200/04; G06T 2207/20104

(57) ABSTRACT

A three-dimensional depiction of an object to be tracked may be tracked using a depth sensing camera. An indication of the object's movement is developed. Also, an amount of pixels in the depiction that are not part of the object is estimated. Then the indication is corrected based on said amount of pixels that are not part of the object.

### BACKGROUND

This relates to tracking moving objects. In a number of applications, it is important to know how an object moves. For example, in connection with detecting hand or gestural inputs to a computer system, the position and the motion of the hand must be tracked. As another example, the user's head may be tracked as part of an eye gaze detection technology. A variety of other objects, including people, may be tracked for security or other purposes.

A three-dimensional camera may improve tracking results. However, traditional tracking systems use both a fast and efficient short term tracker, and an extensive long term component that compensates for the limitations of the short term tracker. It is desirable to use the short term tracker to the greatest possible extent because long term trackers are generally more computer intensive which means that they tax the resources of the computer system to a greater degree which may adversely affect performance.

Generally there is a trade-off for any short term tracker between its ability to adapt to small changes in an object's appearance and the danger of drifting away from the tracked object. To obtain a fast and efficient tracking system, it is desirable to keep the short term tracker working as long as possible without the assistance of the more computer extensive component.

### BRIEF DESCRIPTION OF THE DRAWINGS

Some embodiments are described with respect to the following figures:

FIG. 1 is a flow chart for one embodiment;

FIG. 2 is a flow chart for one component of the sequence shown in FIG. 1;

FIG. 3 shows a scene with a bounding box overlay on the left, a depth map for the bounding box in the center, and a histogram for the bounding box on the right according to one embodiment;

FIG. 4 is a schematic depiction of components used to make the object tracking apparatus more robust according to one embodiment;

FIG. 5 is a system depiction for one embodiment; and

FIG. 6 is front elevation of a system according to one embodiment.

### DETAILED DESCRIPTION

A short term object tracker can be corrected using the depth information provided by a three-dimensional or depth sensing camera without extensive computer resource taxation in some embodiments. Conventional short term trackers continuously update an object model with each new frame. Using a weighting factor, one can diminish the contribution of the tracker's current results according to an estimated percentage of non-object pixels for the currently tracked object. The currently tracked object may be identified or limited to a bounding box that surrounds the moving tracked object. The current results may be diminished using the depth information to detect occlusion in front of the tracked object and background behind the tracked object.

As used herein a three-dimensional or depth sensing camera is any imaging device that obtains information about the depth of an object depicted in an image. A depth camera includes but is not limited to a camera that projects and senses infrared light. Depth sensing or three-dimensional cameras may be implemented using stereoscopic imaging systems, structured light systems and laser scanners, as additional examples.

As used herein, a short term tracker tracks an object based on differences between a small number of frames and only tracks the object while it is within the field of view. The object model is simply an electronic representation of the object to be tracked.

In one embodiment, a kernelized correlation filter (KCF) short term tracker may be used. However, the principles described herein work with any visual tracker that uses a continuously adapted object model. In a continuously adapted object model, the model is updated for each new frame.

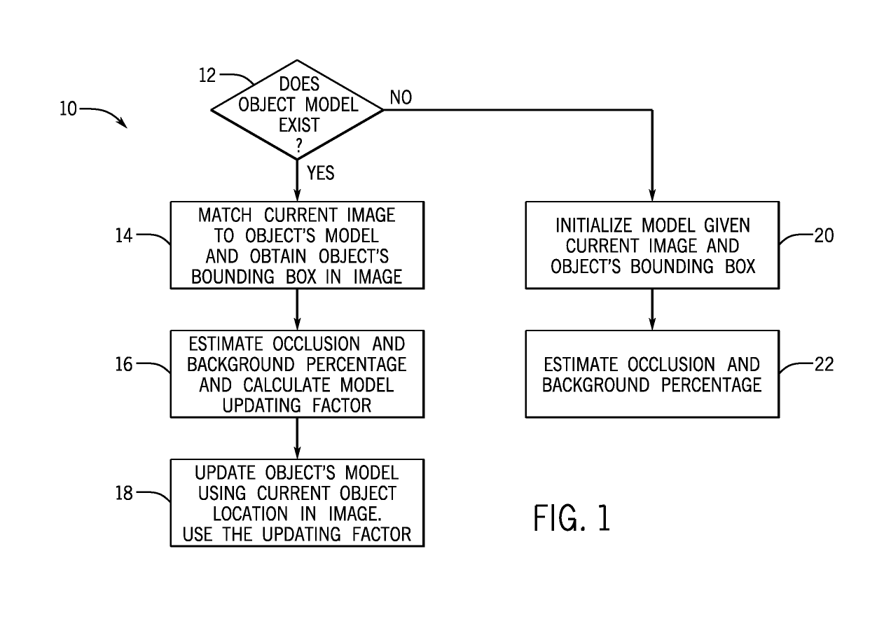

A sequence, shown in FIG. 1, may be implemented in software, hardware and/or firmware. In software and firmware embodiments, it may be implemented by computer executed instructions stored in one or more non-transitory computer readable media, such as magnetic, optical or semiconductor storage.

The sequence begins by detecting whether an object model exists as indicated in diamond 12. If so, the current object is matched to the object's model and the object's bounding box in the captured image is obtained as shown in block 14. Then the occlusion and background pixel percentages are estimated and a model updating factor is calculated as indicated in block 16. Finally, the object's model is updated using the current object location in the image using the updating factor as indicated in block 18.

If the object model does not yet exist as determined in diamond 12, the model is initialized given a current image and the object's bounding box as indicated in block 20. Then the occlusion and background percentages are estimated as indicated in block 22.

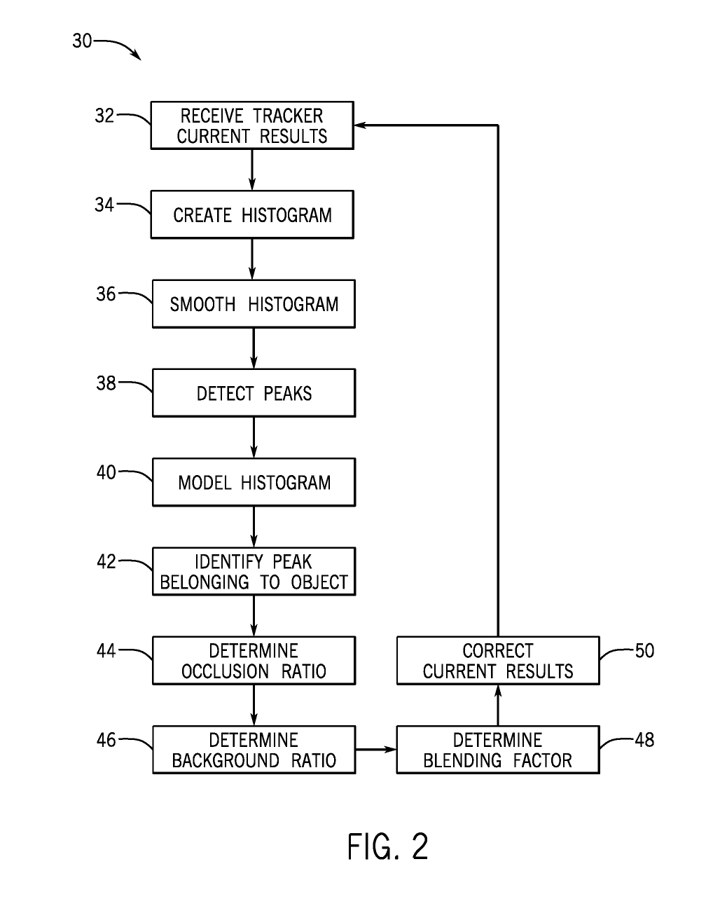

Estimated occlusion and background percentages are calculated using the sequence 30 shown in FIG. 2 in one embodiment. The sequence 30 may be implemented in software, firmware and/or hardware. In software and firmware embodiments it may be implemented using computer implemented instructions stored in one or more non-transitory computer readable media such as magnetic, optical or semiconductor storage.

The sequence begins by receiving tracker current results as indicated in block 32. Typically these are short term tracker results. A histogram is created for all the depth points within a bounding box identifying the object to be tracked, as indicated in block 34. This is done by putting the data into depth differentiated bins, where each bin defines a depth range. The histogram is smoothed to remove insignificant results, as indicated in block 36. This may be done by a low-pass filter or by using a soft histogram in the first place, to give two examples. A soft histogram bins the depth data by allocating the depth data to more than one bin based on how close data falling in one of the bins is to an adjacent bin.

Then peaks in the histogram are detected as indicated in block 38. This may be done by finding the negative zero crossings of the first derivative, for example.

Next each peak is modeled using a Gaussian distribution such as one dimensional Gaussian mixture model (GMM) modeling, as indicated in block 40. The peak belonging to the object is identified as indicated in block 42. The peak belonging to the object may be the largest peak if this is the initial frame and otherwise it is a peak with the largest object, with the object Gaussian identified in a previous frame.

Next the occlusion ratio is determined as indicated in block 44. The occlusion ratio is a ratio the sum of the area under peaks closer to the object divided by the sum of the area of peaks closer to the object added to the area under the object's peak.

Next the background ratio is determined as indicated in block 46. In one embodiment, it may be determined as the sum of area under peaks further away than the object divided by the sum of the area under the peaks further away than the object added to the area under the object's peak.

Next a blending factor is identified as indicated in block 48. The blending factor may be a maximum of one minus two times the quantity of the occlusion ratio minus the background ratio. Then the resulting short term results obtained in block 32 are corrected as indicated in block 50 using the blending factor and the flow iterates to the next frame.

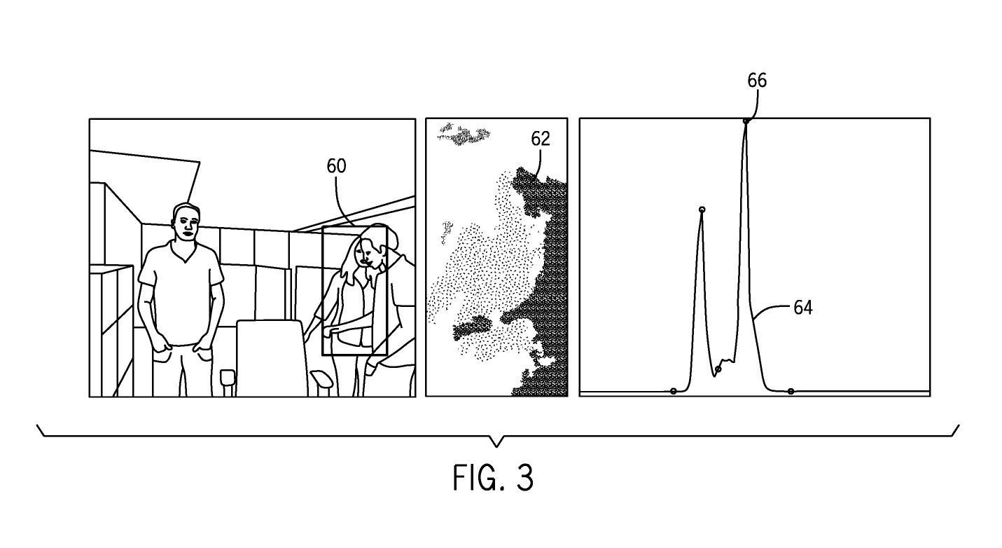

In some embodiments, a method may be relatively fast and may use a simple one dimensional Gaussian mixture model to model the object tracked. In a person tracking application, the Gaussian may be tuned to include a person in one peak and to separate two persons, one immediately in front of the other. Thus, as shown in FIG. 3, a person passing in front of the tracked person is shown in the bounding box. The image with the bounding box 60 is depicted on the left, the resulting in depth map within the bounding box is depicted at 62 and the histogram is shown at 64. The tracked object corresponds to the peak 68 further away to the right. Each peak corresponds to one of the two people shown in the bounding box.

An object model is updated by blending the current model and the new model obtained from the current frame. A common blending factor is in the range of αε[0.01, 0.1]. The larger the factor, the greater the adaptive rate. This allows tracking of an object with fast appearance change. The blending factor is multiplied by the occlusion factor minus the blending factor.

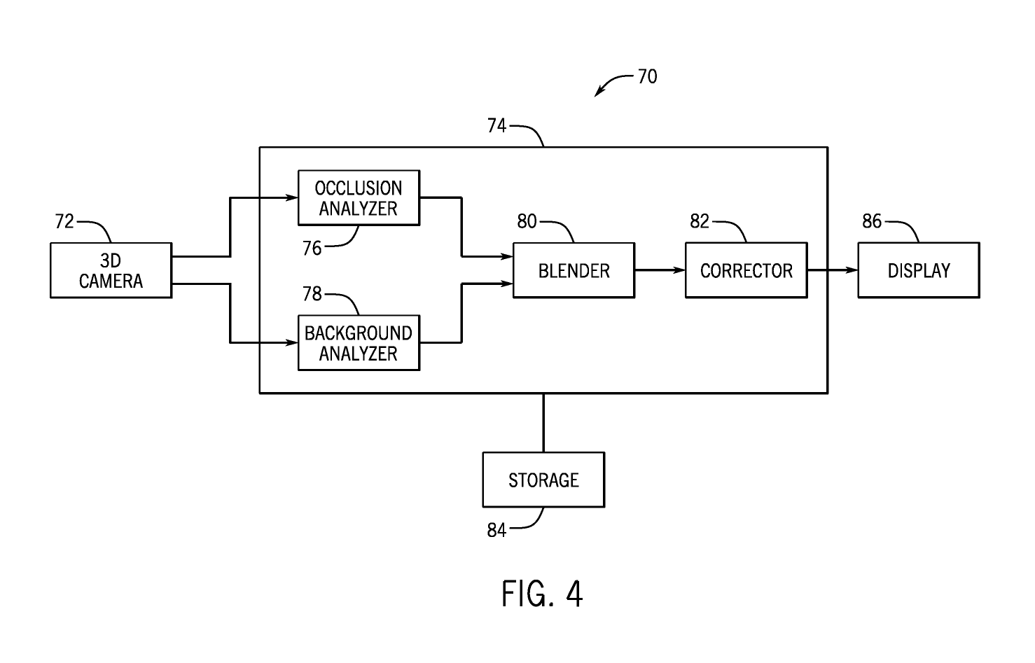

Thus, referring to FIG. 4, a computer 70 may be coupled to a three-dimensional (3D) camera 72. In some embodiments, more than one camera 72 may be used. The output from the camera is continuously fed to an occlusion analyzer 76 that determines occlusion ratio and a background analyzer 78 that determines the background ratio. The results from the analyzers 76 and 78 are blended in the blender 80 to create the correction factor determined by a corrector 82. A storage 84 may be coupled to the processor 74 and the output from the corrector may be coupled to a display 86. That display shows the object tracking results.

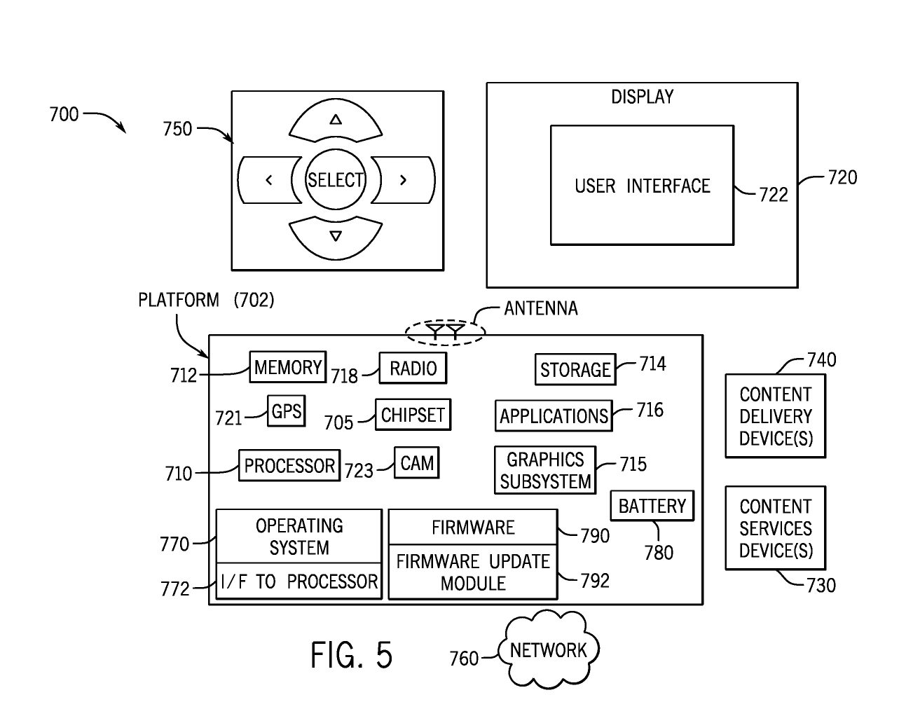

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequences of FIGS. 1 and 2 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

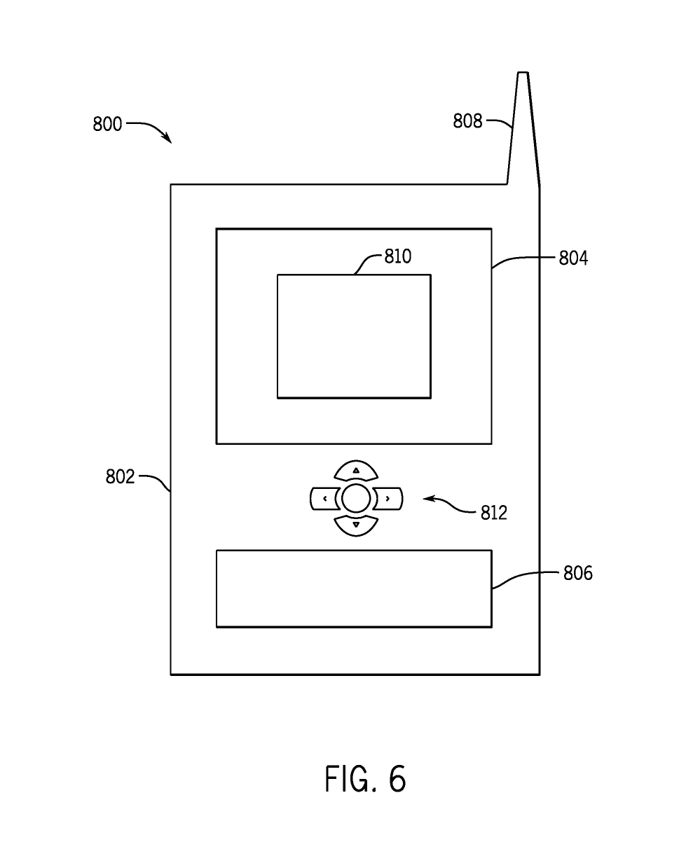

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As shown in FIG. 6, device 800 may comprise a housing 802, a display 804 and 810, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The following clauses and/or examples pertain to further embodiments:

One example embodiment may be a method comprising capturing a three-dimensional depiction of an object to be tracked using a depth sensing camera, developing an indication of the object's movement, estimating an amount of pixels in the depiction that are not part of the object and correcting the indication based on said amount of pixels that are not part of the object. The method may also include estimating occlusion in front of the object. The method may also include wherein estimating background behind the object. The method may also include wherein estimating background behind the object. The method may also include using a kernelized correlation filter short term tracker. The method may also include detecting whether an object model exists. The method may also include if an object model exists, matching the object's model to a current object. The method may also include obtaining a bounding box around the captured object. The method may also include estimating occlusion and background percentages. The method may also include creating a histogram of depth points within the object to be tracked.

Another example embodiment may be one or more non-transitory computer readable media storing instructions to perform a sequence comprising capturing a three-dimensional depiction of an object to be tracked using a depth sensing camera, developing an indication of the object's movement, estimating an amount of pixels in the depiction that are not part of the object, and correcting the indication based on said amount of pixels that are not part of the object. The media may include further storing instructions to perform a sequence including estimating occlusion in front of the object. The media may include further storing instructions to perform a sequence wherein estimating background behind the object. The media may include further storing instructions to perform a sequence wherein estimating background behind the object. The media may include further storing instructions to perform a sequence including using a kernelized correlation filter short term tracker. The media may include further storing instructions to perform a sequence including detecting whether an object model exists. The media may include further storing instructions to perform a sequence including, if an object model exists, matching the object's model to a current object. The media may include further storing instructions to perform a sequence including obtaining a bounding box around the captured object. The media may include further storing instructions to perform a sequence including estimating occlusion and background percentages. The media may include further storing instructions to perform a sequence including creating a histogram of depth points within the object to be tracked.

In another embodiment an apparatus may include a processor to capture a three-dimensional depiction of an object to be tracked using a depth sensing camera, develop an indication of the object's movement, estimate an amount of pixels in the depiction that are not part of the object, correct the indication based on said amount of pixels that are not part of the object, and a memory coupled to said processor. The apparatus may include said processor to estimate occlusion in front of the object. The apparatus may include said processor to estimate background behind the object. The apparatus may include said processor to estimate background behind the object. The apparatus may include said processor to use a kernelized correlation filter short term tracker. The apparatus may include said processor to detect whether an object model exists. The apparatus may include said processor to, if an object model exists, matching the object's model to a current object. The processor may include said processor to obtain a bounding box around the captured object. The processor may include said processor to estimate occlusion and background percentages. The processor may include said processor to create a histogram of depth points within the object to be tracked.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. The method comprising:
capturing a three-dimensional depiction of an object to be tracked using a depth sensing camera;
developing an indication of the object's movement;
estimating an amount of pixels in the depiction that are not part of the object; and
correcting the indication based on said amount of pixels that are not part of the object.

2. The method of claim 1 including estimating occlusion in front of the object.

3. The method of claim 1 wherein estimating background behind the object.

4. The method of claim 2 wherein estimating background behind the object.

5. The method of claim 1 including using a kernelized correlation filter short term tracker.

6. The method of claim 1 including detecting whether an object model exists.

7. The method of claim 6 including, if an object model exists, matching the object's model to a current object.

8. The method of claim 7 including obtaining a bounding box around the captured object.

9. The method of claim 1 including estimating occlusion and background percentages.

10. The method of claim 8 including creating a histogram of depth points within the object to be tracked.

11. One or more non-transitory computer readable media storing instructions to perform a sequence comprising:
capturing a three-dimensional depiction of an object to be tracked using a depth sensing camera;
developing an indication of the object's movement;
estimating an amount of pixels in the depiction that are not part of the object; and
correcting the indication based on said amount of pixels that are not part of the object.

12. The media of claim 11, further storing instructions to perform a sequence including estimating occlusion in front of the object.

13. The media of claim 11, further storing instructions to perform a sequence wherein estimating background behind the object.

14. The media of claim 12, further storing instructions to perform a sequence wherein estimating background behind the object.

15. The media of claim 11, further storing instructions to perform a sequence including using a kernelized correlation filter short term tracker.

16. The media of claim 11, further storing instructions to perform a sequence including detecting whether an object model exists.

17. The media of claim 16, further storing instructions to perform a sequence including, if an object model exists, matching the object's model to a current object.

18. The media of claim 17, further storing instructions to perform a sequence including obtaining a bounding box around the captured object.

19. The media of claim 11, further storing instructions to perform a sequence including estimating occlusion and background percentages.

20. The media of claim 18, further storing instructions to perform a sequence including creating a histogram of depth points within the object to be tracked.

21. An apparatus comprising:
a processor to capture a three-dimensional depiction of an object to be tracked using a depth sensing camera, develop an indication of the object's movement, estimate an amount of pixels in the depiction that are not part of the object, correct the indication based on said amount of pixels that are not part of the object; and
a memory coupled to said processor.

22. The apparatus of claim 21, said processor to estimate occlusion in front of the object.

23. The apparatus of claim 21, said processor to estimate background behind the object.

24. The apparatus of claim 22, said processor to estimate background behind the object.

25. The apparatus of claim 21, said processor to use a kernelized correlation filter short term tracker.

26. The apparatus of claim 21, said processor to detect whether an object model exists.

27. The apparatus of claim 26, said processor to, if an object model exists, matching the object's model to a current object.

28. The apparatus of claim 27, said processor to obtain a bounding box around the captured object.

29. The apparatus of claim 21 including a display communicatively coupled to the processor.

30. The apparatus of claim 21 including a battery coupled to the processor.
